(19) United States
(12) Patent Application Publication
(10) Pub. No.: US 2015/0369369 A1
(43) Pub. Date: Dec. 24, 2015

(54) MECHANICAL SEAL ARRANGEMENT HAVING AN IMPROVED SECONDARY SEAL

(71) Applicant: EAGLEBURGMANN GERMANY GMBH & CO. KG, Wolfratshausen (DE)

(72) Inventors: Joachim Otschik, Beuerberg (DE); Peter Droscher, Geretsreid (DE); Andreas Fesl, Otterfing (DE); Thomas Holzapfel, Sindelsdorf (DE); Klaus Lang, Beuerberg (DE); Gunther Lederer, Geretsried (DE); Petia Philippi, Wolfratshausen (DE); Rudolf Schicktanz, Geretsreid (DE); Andreas Schrufer, Wolfratshausen (DE); Berthold Vogel, Schwieberdingen (DE)

(21) Appl. No.: 14/443,121

(22) PCT Filed: Nov. 7, 2013
(86) PCT No.: PCT/EP2013/003353

§ 371 Date: May 15, 2015

(30) Foreign Application Priority Data
Nov. 15, 2012 (DE) 10 2012 022 465.6

(51) Int. Cl. F16J 15/34

(52) U.S. Cl. CPC F16J 15/3452; F16J 15/3464

(57) ABSTRACT

The invention refers to a mechanical seal arrangement, comprising: a rotatable seal ring (2), a stationary seal ring (3) and a secondary seal device (5), said secondary seal device (5) being made in one piece and comprising a secondary seal (51) and a ring element (52) of different materials, and the ring element (52) being arranged on the secondary seal (51) on a side directed to the stationary seal ring (3).

The present invention refers to a mechanical seal arrangement having an improved secondary seal.

A set of problems in known mechanical seal arrangements are secondary seals which are often to perform sealing on a rear side, i.e. on a side opposite to the sealing gap, of a seal ring. To this end the secondary seals must be kept axially movable so as to compensate especially also axial shifts between shaft and housing during standstill or slow running of a machine and to guarantee sealing. Due to the high pressures and high temperatures which are normally prevailing during operation of the mechanical seal arrangement, the secondary seals deform plastically, which may then lead in the case of a standstill of the machine to an undesired shrinking of the secondary seal onto a sleeve-like component due to temperature reduction and pressure reduction. The axial movability of the secondary seal, however, may be reduced thereby, and leakage between the two seal rings may occur during standstill or upon restart of the machine, or leakage may occur on the rear side of the seal ring on which the secondary seal is arranged. DE 20 2007 017 783.6 U1 discloses a mechanical seal arrangement in which a support ring is loosely arranged between a secondary seal and a seal ring to avoid potential shear stresses between the parts, which are caused by different thermal expansions of the components, also at high temperatures and particularly at high mechanical stresses. Furthermore, a film-like intermediate layer of PEEK is here disposed between the support ring and the secondary seal. This film-like intermediate layer is also to prevent disadvantageous impacts caused by different thermal expansion coefficients on the seal ring and the secondary seal, respectively.

It is therefore the object of the present invention to provide a mechanical seal arrangement having a secondary seal device which in all operative states, particularly during or after standstill, allows a safe and leakage-free sealing while being of a simple structure and being producible in a simple manner at low costs.

This object is achieved by a mechanical seal arrangement comprising the features of claim 1. The sub-claims show preferred developments of the invention.

Hence, the mechanical seal arrangement of the invention with the features of claim 1 has the advantage that also in case of a standstill or during slow running or restart a sufficiently axial movability of the secondary seal is ensured. It can particularly be prevented according to the invention that the secondary seal device gets stuck or is shrunk onto a tubular component after cooling, which would prevent the axial movability of the secondary seal device. This is achieved according to the invention in that the secondary seal device is made integral with a ring element (ring element part) and a secondary seal (secondary seal part). This ring element is here arranged on a side of the secondary seal which is directed towards the stationary seal ring. The secondary seal and the ring element are here made of different materials and have an inseparable connection between them so as to provide the one-piece secondary seal device. Thus, the axial movability of the secondary seal device can be maintained by fixing the ring element to the secondary seal to form a single component. Furthermore, the ring element provides a distance in axial direction between the seal ring and the secondary seal, so that in particular also a possible extrusion occurring during operation, i.e. pulling of material of the secondary seal into a gap between the seal ring and the annular component, can be avoided.

Preferably, the connection between the secondary seal and the ring element is a connection established by way of thermal methods, particularly a sinter connection. The sinter connection provides an inseparable connection between the secondary seal and the ring element and can be formed in a particularly simple and inexpensive manner. For instance, granular or powder-like substances for the secondary seal and the ring element can be introduced into a mold and sintered jointly, or alternatively the ring element is sintered onto the already produced secondary seal, or the secondary seal is sintered onto the ring element. Further preferably, secondary seal devices which are produced with other methods are alternatively also possible, e.g. as one-piece injection molded parts made of at least two different materials, or with rapid prototyping methods, e.g. by means of laser sintering, wherein especially the secondary seal device can be produced rapidly and at low costs by way of a layerwise build-up. Further alternatively, the connection between secondary seal and ring element is an adhesive connection.

Further preferably, the mechanical seal arrangement comprises a biasing device for biasing the secondary seal device in axial direction. The biasing device comprises a pressure ring and a biasing element, preferably several springs distributed over the circumference, with the pressure ring resting on the secondary seal.

Further preferably, the pressure ring grips over the secondary seal of the secondary seal arrangement at least in part in axial direction. Especially the secondary seal device can thereby be held in position additionally by the pressure ring even in case of strong temperature variations. The pressure ring lies only loosely on the secondary seal device. According to a further preferred variant of the invention the pressure ring grips under a part of the secondary seal in axial direction by means of an axial projection. The secondary seal is thereby held in position by the pressure ring, and it can counteract a shrink-on tendency of the secondary seal. Particularly preferably, the pressure ring grips over and under a part of the secondary seal.

Further preferably, the pressure ring grips behind the secondary seal by means of a portion gripping behind it.

According to a further preferred variant of the invention the ring element of the secondary seal device has an annular extension extending in axial direction. This annular extension grips over the secondary seal, preferably on a radially outermost portion, in axial direction at least in part. It can thereby be ensured that the ring element preferably extends over the whole radial height of the secondary seal and additionally grips over the secondary seal in axial direction. Tilting forces which might particularly occur and would lead to a tilting of the stationary seal ring can thereby be prevented.

According to an alternative variant of the present invention the secondary seal of the secondary seal device has an axially protruding shoulder on the side directed towards the stationary seal ring. Furthermore, the ring element comprises an axially extending annular extension which grips over the protruding shoulder of the secondary seal.

Further preferably, the connection is formed on the whole contact area between the secondary seal and the ring element. This ensures a reliable connection between the two components, so that the secondary seal device has a long service life as a one-piece component. Furthermore, shear forces can be transmitted in a very reliable manner.

Preferably, the ring element comprises a high-performance plastic, particularly PEEK or PEK or PEKEKK.

Particularly preferably, the secondary seal comprises PTFE and the ring element comprises PEEK. It is ensured through the selection of preferably PEEK as the material for the ring element that the pressure ring counteracts a shrink-on tendency of the PTFE secondary seal and of the PEEK ring element in the case of a temperature reduction owing to the firm connection between the PEEK ring element and the PTFE secondary seal. Thus, a possible shrinkage force on the PEEK ring element and the PTFE secondary seal can be reduced, and shrinking onto a tubular component can be avoided, so that the axial movability of the secondary seal device can always be maintained. Furthermore, an extrusion of the softer PTFE secondary seal into the gap between the tubular component and the stationary seal ring can be avoided by way of the harder PEEK ring element. Hence, the use of an extrusion-stable material for the ring element also allows a reduction of said gap between the stationary seal ring and the tubular component. Alternatively, a material mixture, comprising PEEK, can be used as the material for the ring element, and a material mixture, comprising PTFE, for the secondary seal.

Preferably, the ring element of the secondary seal device has a length L1 on a side directed towards a tubular component, and the secondary seal has a length L2 in axial direction on a side directed towards a tubular component, the length L2 being at least twice as large, and preferably three times as large as length L1. Particularly preferably, length L1 is within a range of 0.1 mm to 2 mm, preferably between 0.4 mm and 0.8 mm. Preferably, the axial length L2 of the secondary seal is in a range of 2 mm to 12 mm, particularly of 4 mm to 10 mm, and preferably between 3 mm and 8 mm, and preferably 3 mm and 6 mm. Further preferably, a total length L3 of the one-piece secondary seal device is not more than 14 mm. In other words, a sum of the lengths L1+L2 is not more than 14 mm.

According to a further preferred variant of the invention a form-fit connection is provided between the secondary seal device and the pressure ring. The form-fit connection is particularly formed between the secondary seal and the pressure ring. Particularly preferably, the secondary seal device is arranged on the pressure ring such that the secondary seal device is suspended from the pressure ring, i.e. the pressure ring grips under a part of the secondary seal device, so that especially also the undesired shrink-on process becomes even more unlikely during cooling of the secondary seal device owing to this measure because the pressure ring retains the secondary seal device. Particularly preferably, the form-fit connection is formed between the secondary seal device and the pressure ring by way of an annular anchorage, wherein preferably the secondary seal comprises an annular projecting portion which is received in an annular groove in the pressure ring.

Further preferably, the mechanical seal arrangement is a gas seal for sealing a gaseous medium. Alternatively, the mechanical seal arrangement is preferably a liquid seal for sealing a liquid medium or a gas-liquid mixture.

Preferred embodiments of the invention will now be described in detail with reference to the accompanying drawing. In the drawing,

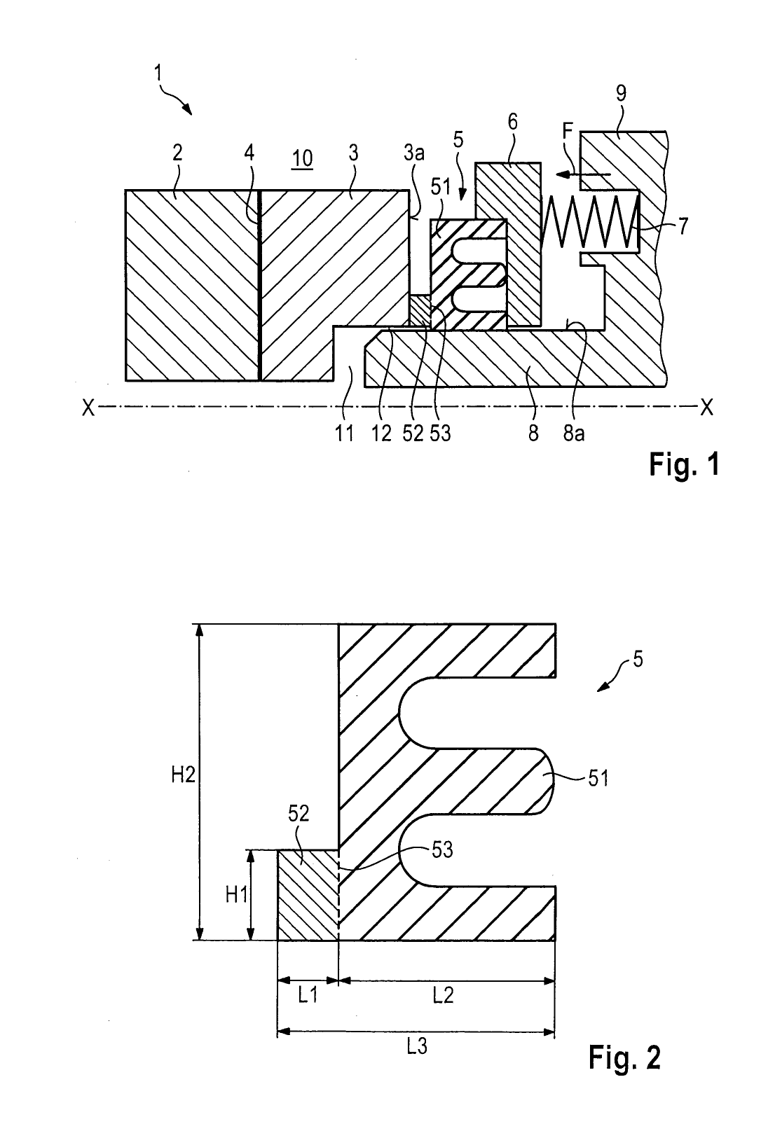

FIG. 1 is a schematic sectional view of a mechanical seal arrangement according to a first embodiment of the invention.

FIG. 2 is an enlarged view of a secondary seal device of FIG. 1.

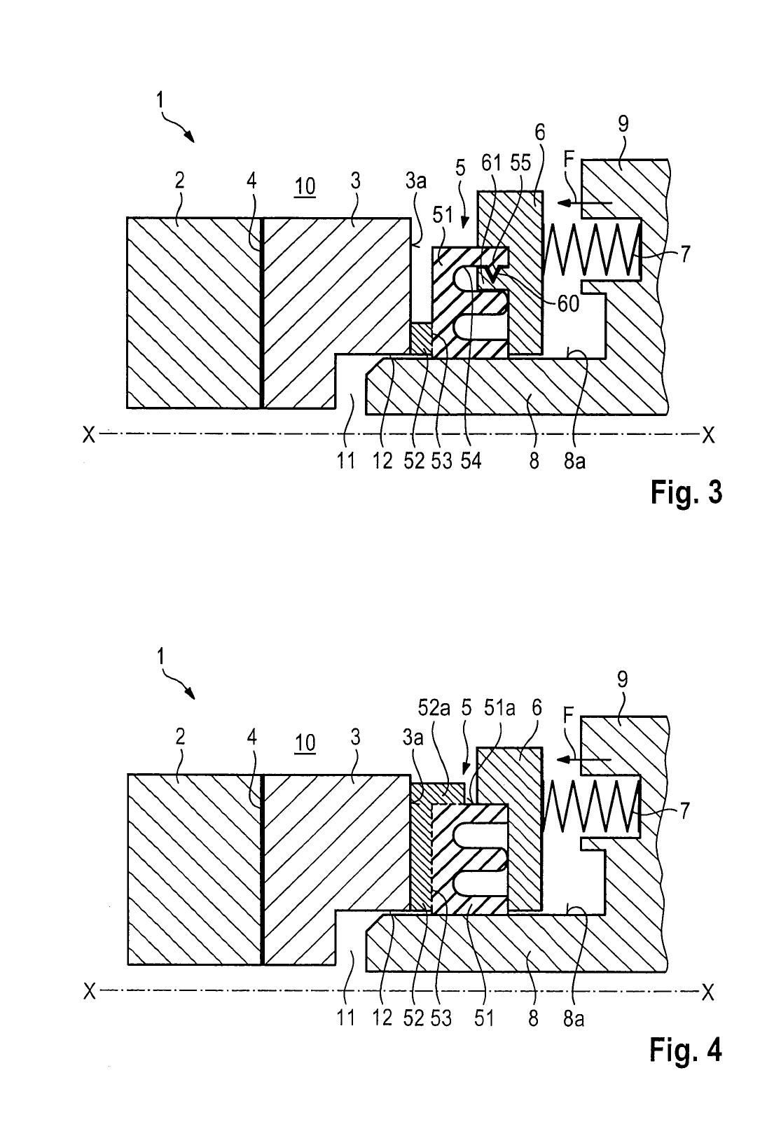

FIG. 3 is a schematic sectional view of a mechanical seal arrangement according to a second embodiment of the invention.

FIG. 4 is a schematic sectional view of a mechanical seal arrangement according to a third embodiment of the invention.

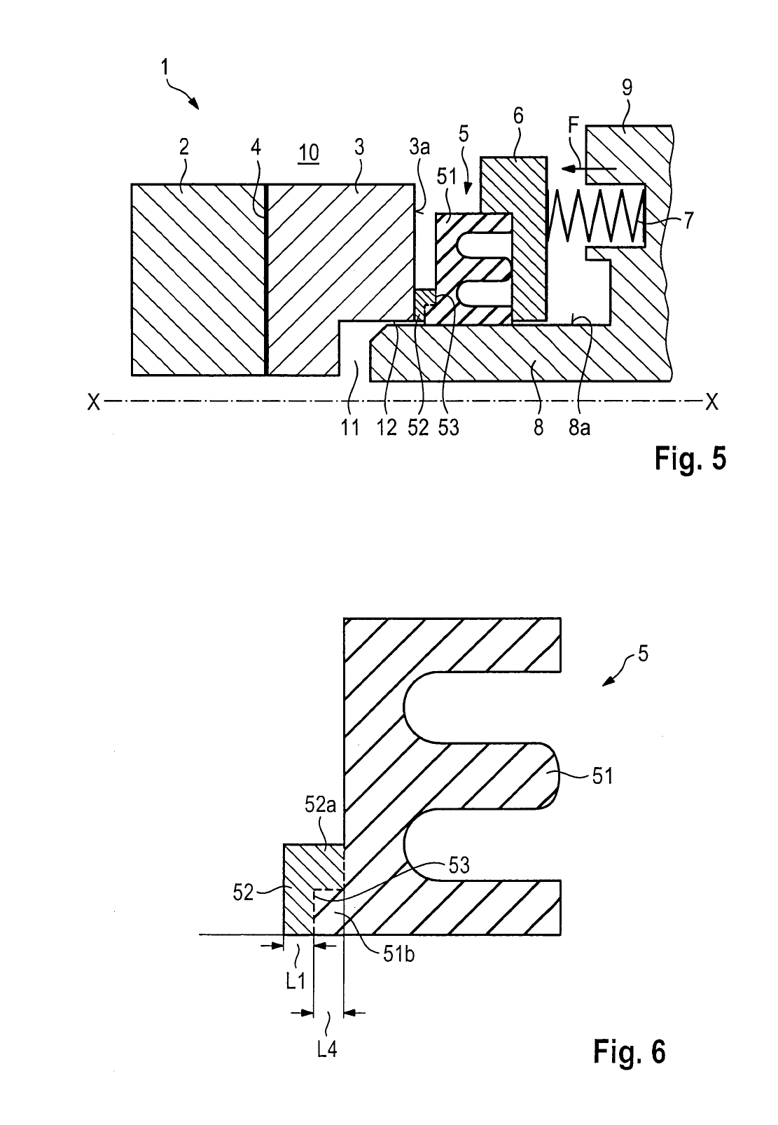

FIG. 5 is a schematic sectional view of a mechanical seal arrangement according to a fourth embodiment of the invention.

FIG. 6 is an enlarged illustration of a secondary seal device of FIG. 5, and

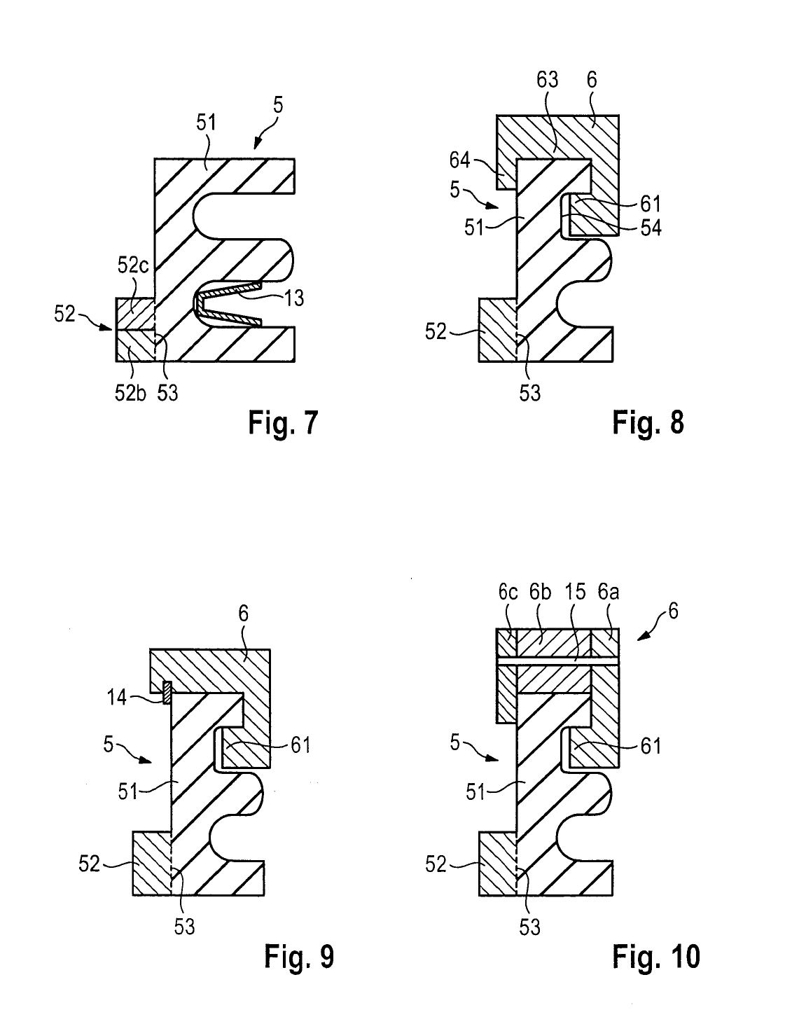

FIGS. 7 to 10 show further preferred alternatives of the secondary seal device of the invention.

Identical or technically functionally identical components are designated with the same reference numerals in the embodiments described hereinafter.

A mechanical seal arrangement 1 according to a first embodiment of the invention is now described in detail with reference to FIGS. 1 and 2.

As can be seen in FIG. 1, the mechanical seal arrangement 1 comprises a rotating mechanical seal ring 2 and a stationary seal ring 3 which form a sealing gap 4 between them in a known manner. The rotating seal ring 3 is connected to a rotating component (not shown), such as e.g. a shaft. The mechanical seal arrangement 1 shown in FIG. 1 is a so-called pressure seal which seals a pressurized gas in a pressure area 10 against an atmosphere area 11.

The mechanical seal arrangement 1 further comprises a one-piece secondary seal device 5 with a separate pressure ring 6. The secondary seal device 5 comprises the secondary seal 51 proper and a ring element 52 which is inseparably connected to the secondary seal 51. In this embodiment the secondary seal 51 and the ring element 52 are made from different sinter materials, so that a sinter connection 53 is formed between the secondary seal 51 and the ring element 52. This sinter connection 53 is inseparable so as to form the one-piece secondary seal device. According to the invention the term “inseparable” stands for a connection which can only be separated by being destroyed. As sinter materials, PTFE is used for the secondary seal 51 and PEEK for the ring element 52 in this embodiment, or mixtures with said materials.

As can particularly be seen in FIG. 2, a length L1 in axial direction X-X of the ring element 52 is here about three times smaller than a length L2 of the secondary seal 51 in axial direction. A total length L3=L1+L2 is ≦14 mm. Furthermore, a radial height H2 of the secondary seal 51 is at least twice as large as a radial height H1 of the ring element 52 (cf. FIG. 2).

The mechanical seal 1 further comprises a biasing device with a biasing element 7, in this embodiment a spring. The biasing element 7 exerts a biasing force F in axial direction on the separate pressure ring 6 which transmits the biasing force via the one-piece secondary seal device 5 to the stationary seal ring 3. In case of a standstill or when the machine is started or shut down, the medium passes via the mechanical seal 4 from the pressure area 10 into the atmosphere area 11 and the stationary seal ring 3 is thus pressed in axial direction against the rotatable seal ring 2.

The one-piece secondary seal device 5 must therefore seal on a tubular component 8 of a housing 9 in all operative states. The tubular component 8 comprises an outer sealing surface 8a on which the secondary seal device 5 seals. During operation the secondary seal 51 seals on the outer sealing surface 8a and the ring element 52 seals on a rear portion 3a of the stationary seal ring 3.

The one-piece secondary seal device 5 according to the invention thereby makes it possible to provide a one-part component made of two different materials. The ring element 52 particularly provides a reduced radial friction force towards the seal ring 3. Since the ring element 52 is connected to the secondary seal 51 in a planar manner via the sinter connection 53, there is a reduced risk—also particularly during standstill or cooling of the machine—that the one-piece secondary seal device 5 is shrunk onto the tubular component. Especially during standstill or upon start or shut-down a situation can be avoided where leakage occurs through the sealing gap 4 between the two seal rings due to a secondary seal device 5 being stuck onto the tubular component 8 because the stationary seal ring 3 cannot carry out the axial movement because of the stuck-on one-piece secondary seal device 5. Furthermore, the use of the ring element 52 consisting of a material differing from that of the secondary seal 51 makes it possible to prevent a situation where the material is pulled from the secondary seal device 5 into the gap 12 between the stationary seal ring 3 and the tubular component 8, which in the prior art poses a great problem regarding the stability of the secondary seals. Preferably, the length L1 in axial direction is at least two to three times greater than an axial extension of the gap 12.

Hence, in comparison with the prior art solutions that have so far been known and respectively use a great number of individual separate rings on the secondary seal, the present invention offers great advantages during start and shutdown and during standstill of the machine. The one-piece secondary seal device 5 according to the invention is also particularly suited for sealing media with high pressures and high temperatures.

FIG. 3 shows a mechanical seal arrangement 1 according to a second embodiment which substantially conforms to the first embodiment. In contrast to the first embodiment the mechanical seal arrangement 1 of the second embodiment additionally comprises a suspended one-piece secondary seal device 5. To this end, on a side facing away from the stationary seal ring 3, the secondary seal 51 has an annular indentation 54 into which an axial projection 61 of the pressure ring 6 is protruding. A form-fit connection exists between the projection 61 and the secondary seal 51, the connection including a projecting portion 55 on the secondary seal and an annular recess 60 on the projection 61 (cf. FIG. 3). Viewed in section, the form-fit connection has a V-shape. Owing to this measure the one-piece secondary seal device 5 is suspended from the pressure ring 6, or the pressure ring 6 grips under a part of the secondary seal device 5, so that particularly the tendency to shrinking onto the tubular component 8 during standstill of the machine is further reduced.

FIG. 4 shows a mechanical seal arrangement 1 according to a third embodiment of the invention, which substantially conforms to the first embodiment. In contrast to the first embodiment, the one-piece secondary seal device 5 is made different in the third embodiment. As can be seen in FIG. 4, the ring element 52 in radial direction is greater than the secondary seal 51 and grips over the secondary seal 51 on a radially outer circumference 51 by means of an over-gripping portion 52a. Especially the connection 53 between the secondary seal 51 and the ring element 52 is thereby provided on a larger area. Furthermore, the over-gripping arrangement of the ring element 52 on the secondary seal 51 lowers a tendency of the secondary seal 51 particularly arising upon temperature changes, viz. to tilt in the direction of the pressure ring 6, whereby the sealing gap 4 between the two seal rings 2, 3 can be influenced in a negative manner.

FIGS. 5 and 6 show a mechanical seal arrangement 1 according to a fourth embodiment of the invention. In this embodiment, the secondary seal 51 comprises a shoulder 51b projecting in axial direction X-X (cf. FIG. 6). The ring element 52 comprises again an over-gripping portion 52a and grips over the shoulder 51b. An undesired tilting movement tendency of the secondary seal 51 is thereby reduced. As can particularly be seen in FIG. 6, an axial length L1 of the ring element 52 in the area of the tubular component 8 has approximately the same size as an axial length L4 of the shoulder 51b in axial direction X-X.

FIGS. 7 to 10 show further preferred embodiments of the secondary seal device 5 according to the invention.

FIG. 7 shows a preferred embodiment, in which the ring element 52 has a multilayered structure. In this embodiment, the ring element 52 has a two-layered structure with a first layer 52b and a second layer 52c. It is however possible that more layers are provided for the ring element 52. Furthermore, the secondary seal 51 comprises a spreading element 13 which is arranged in a correspondingly formed recess in the secondary seal 51. The two layers shown in FIG. 8 are made from different materials, the hardness of the layers preferably decreasing in a radially outer direction. This means that the first layer 52b is harder than the second layer 52c. Both layers 52b and 52c, however, are connected via the sinter connection 53 to the secondary seal 51. Furthermore, a spreading element 13 is arranged on the secondary seal 51 to ensure that the secondary seal 51 reliably rests on a tubular component.

FIG. 8 shows a further preferred alternative of the present invention, wherein the secondary seal device 5 is suspended by means of the secondary seal 51 from the pressure ring 6. To this end the pressure ring 6 has an axial projection 61 which engages into an indentation 54 on the secondary seal 51. The secondary seal is thereby suspended from the pressure ring 6. The pressure ring 6 further comprises an over-gripping portion 63 and a portion 64 gripping behind. The total portion of the secondary seal 51 which is directed in a radially outwardly oriented direction is thereby covered by the pressure ring 6 (cf. FIG. 8). Since the pressure ring 6 is very stiff, this preferred variant thereby additionally counteracts particularly a tilting of the secondary seal 51 and prevents a shrinking-on of the secondary seal device 5 under a shaft, or the like.

FIG. 9 shows a further preferred embodiment of the invention, which is substantially similar to that of FIG. 8, wherein, instead of the portion 64 gripping behind, a retaining ring 14 is arranged in the embodiment in FIG. 9 on the pressure ring 6, which grips behind the secondary seal 51.

The further preferred embodiment shown in FIG. 10 shows a further alternative of the pressure ring 6 gripping behind, wherein the pressure ring 6 of FIG. 10 is of a multi-part configuration. In this embodiment the pressure ring 6 comprises three parts 6a, 6b, 6c that are interconnected by means of a pin 15. Particularly the production costs for the pressure ring 6 can thereby be reduced, and the secondary seal 51 can be mounted in a fast and easy manner on the pressure ring 6. In the embodiment shown in FIG. 10, the secondary seal 51 is also suspended from the axial projection 61.

It should be noted with respect to all of the described embodiments that particularly the pressure ring 6 may be configured such that the secondary seal 51 is suspended from the pressure ring 6. Furthermore, in all of the described embodiments, the pressure ring 6 may be built up such that it either grips completely over the secondary seal 51 or completely grips behind the secondary seal 51, as shown in the embodiments of FIGS. 8 to 10. Furthermore, instead of a sintering method, every further suitable method, particularly injection molding, can also be used for producing the one-part secondary seal device 5. Moreover, in all described embodiments, spreading elements 13 may additionally be used on the secondary seal 51 to ensure a reliable sealing of the secondary seal 51 on the tubular component 8.

### LIST OF REFERENCE NUMERALS

1 mechanical seal arrangement
2 rotatable seal ring
3 stationary seal ring
3a rear portion
4 sealing gap
5 secondary seal device
6 pressure ring
6a, 6b, 6c part of the pressure ring
7 biasing element
8 tubular component
8a outer sealing surface
9 housing
10 pressure area
11 atmosphere area
12 gap
13 spreading element
14 retaining ring
15 pin
51 secondary seal
51a radially outer circumference
51b shoulder
52 ring element
52a over-gripping portion
52b first material
52c second material
53 sinter connection
54 indentation
55 projecting portion
60 annular recess
61 axial projection
62 shoulder
63 over-gripping portion
64 portion gripping behind
X-X axial direction
F biasing force

1. Mechanical seal arrangement, comprising:
a rotatable seal ring,
a stationary seal ring and
a secondary seal device,
said secondary seal device being made in one piece and including a secondary seal and a ring element of different materials; and
the ring element being arranged on the secondary seal on a side directed to the stationary seal ring.

2. Mechanical seal arrangement according to claim 1, wherein a connection is established between the secondary seal and the ring element of the one-piece secondary seal device by means of thermal methods, particularly as a sinter connection and/or an adhesive connection.

3. Mechanical seal arrangement according to claim 1, wherein a biasing device for biasing the one-piece secondary seal device in axial direction (X-X), includes a pressure ring and a biasing element, the pressure ring resting on the secondary seal of the secondary seal device.

4. Mechanical seal arrangement according to claim 3, wherein the pressure ring partly grips over the secondary seal of the one-piece secondary seal device in axial direction (X-X) by means of an over-gripping portion and/or partly grips thereunder by means of an axial projection and/or grips behind by means of a portion gripping behind or by means of a retaining ring.

5. Mechanical seal arrangement according to claim 4, wherein the ring element includes a ring extension which extends in axial direction (X-X) and which grips over the secondary seal in axial direction (X-X) at least in part.

6. Mechanical seal arrangement according to claim 5, wherein the ring element grips over the secondary seal on a radially outermost portion or that the ring element grips over the secondary seal on a shoulder formed on the secondary seal.

7. Mechanical seal arrangement according to claim 2, wherein the connection is provided on the whole contact area between the secondary seal and the ring element.

8. Mechanical seal arrangement according to claim 1, wherein the secondary seal comprises PTFE and/or the ring element comprises polyether ketones, particularly PEEK.

9. Mechanical seal arrangement according to claim 1, further comprising a tubular component on which the one-piece secondary seal device seals.

10. Mechanical seal arrangement according to claim 9, wherein the ring element has a length (L1) in axial direction (X-X) on a side directed towards the tubular component, and the secondary seal has a length (L2) in axial direction on a side directed towards the tubular component, and the length (L2) is at least twice as great as the length (L1).

11. Mechanical seal arrangement according to claim 1, wherein a form-fitting connection exists between the secondary seal and the pressure ring.

12. Mechanical seal arrangement according to claim 11, wherein the secondary seal includes an indentation and a portion projecting into the indentation, and the pressure ring includes an annular recess formed to conform to the form of the projecting portion, for the form-fitting connection.

13. Mechanical seal arrangement according to claim 1, wherein the mechanical seal arrangement is a gas seal for sealing a gaseous medium.

14. Mechanical seal arrangement according to claim 1, wherein the mechanical seal arrangement is a liquid seal for sealing a liquid medium
